(19) United States
(12) Patent Application Publication
(10) Pub. No.: US 2009/0294446 A1
(43) Pub. Date: Dec. 3, 2009

(54) Cover Apparatus

(76) Inventor: Kelvin Ray DeJulio, Parker, CO (US)

Correspondence Address: JACKSON ESQUIRE;ROGER A. JACKSON, 209 KALAMATH STREET, UNIT 9, DENVER, CO, 80223-1348, US

(21) Appl. No.: 12/477,043

(22) Filed: Jun. 2, 2009

Related U.S. Application Data
(60) Provisional application No. 61/130,576, filed on Jun. 2, 2008.

(51) Int. Cl. B65D 51/18; B65F 1/06; B65F 1/16

(52) U.S. Cl. 220/254.8; 220/495.11

(57) ABSTRACT

Broadly, the present invention is of a cover apparatus for a container with an interior and having an open end defined by a sidewall edge portion. The cover apparatus includes an annular element with structure to removably engage the sidewall edge portion. Further included in the cover apparatus is a separable disc that is rotationally removably engaged to the annular element, the disc is sized and configured to allow for one-way axial movement relative to the annular element, such that the disc and the annular element substantially enclose the container interior.

### RELATED APPLICATION

This application claims priority from U.S. provisional patent application Ser. No. 61/130,576 filed Jun. 2, 2008 by Kelvin DeJulio.

### TECHNICAL FIELD

The present invention generally relates to a cover apparatus that is removably engaged to a container. More particularly, the present invention is a cover apparatus that allows for retention of a flexible plastic liner on the outer terminating periphery of the container surrounding sidewall while at the same time facilitating open access to the container interior through a second separable removably engagable element.

### BACKGROUND OF INVENTION

When doing yard related landscape activities such as racking up leaves, grass clippings, and the like that comprise what is typically called “compost” material there is typically a need to collect and remove the compost material from the landscape. Usually, this compost material is manually placed in a container, when there are large volumetric amounts of compost material the container typically has placed into it a flexible plastic liner when the container is empty and when the container is filled with the compost material the flexible plastic liner is removed and sealed at its opening thereby holding the compost material. Wherein another flexible plastic bag is disposed within the container interior and the process is repeated of filling the flexible plastic liner that is disposed within the container interior, removing the liner, and sealing the open end of the liner, as the container supports the flexible plastic liner for filling the liner with the compost material. Normally the container has an upper ridge or lip wherein the container surrounding sidewall terminates as it extends from the base and it is this ridge or lip that the excess open end portion of the flexible plastic liner that is folded over the ridge of the container prior to filling the liner with the compost material when the liner is disposed within the container.

The problem that typically occurs is when the compost material is placed within the liner interior, the liner itself tends to slide or move relative to the container surrounding sidewall, with the liner moving from the ridge to the base of the container along the surrounding sidewall. The result of this liner sliding along the surrounding sidewall is that the liner collapses against itself by having no independent rigidity, wherein the compost material tends to pile-up on top of the liner with the compost material then directly contacting the surrounding sidewall of the container. When this happens the benefit of the liner is lost, with the user having to partially empty the container of the compost material in order to retrieve the liner, stretching the liner to re dispose the liner open end portion to be re-folded over the container ridge, and then starting the entire process over of filing the liner disposed within the container with the compost material.

A prior art recognized solution to the problem of the liner sliding off of the container ridge while filling the liner with compost material is to removably retain the folded over portion of the liner to the container ridge by some means. Thus a number of means for removably retaining the liner open end portion to the container ridge are disclosed, wherein the following will review some of the more pertinent prior art in this area. Staring with United States patent application publication number 2008/0179327 to Lin disclosed is a cover means for a trash bin, which is mounted on an upper terminating edge of the surrounding sidewall of the trash bin with the cover means including a support ring disposed upon the upper terminating edge of the trash bin, further a pivotally attached cover is mounted on a portion the support ring. Wherein the pivoting element in Lin is operational to pivotally connect to the support ring and the cover and allowing the cover to be self lifted upward and a buffer/dampener device coupling to the pivoting device that slows down the spring lifting speed of the cover, see Page 1, Paragraph 0007. While the cover is closed in Lin, the pivoting device allows the buffer device to be in a first operational state position, however, while the cover is pressed momentarily downward for opening, the pivoting device is released and provides a spring initiated force to lift the cover to a second operational state position. Simultaneously, in Lin a part of the force of the pivoting device would be cushioned via the buffer device and the buffer device is adapted to slow down the speed of lifting the cover. Thus, in Lin the operation of lifting the cover would be quieter, see Page 1, Paragraph 0008. The application in Lin goes into great detail on the pivotal mechanism, but provides no teaching in the way of the bin outer periphery retainer having a specific retaining interface with a flexible plastic liner that would be disposed within the trash bin.

Continuing in the container cover prior art area, in U.S. Pat. No. 7,243,816 to Aochi, disclosed is a container with one-piece seal annular element and lid with pivoting spring attachment that is similar to Lin in general appearance and function, however, with Aochi being applied to a beverage container. The container body in Aochi includes a rear wall or wall portion and an opposed front wall or front wall portion, further, a complimentary lid engages over the upwardly opening mouth of the container body and is pivotally joined to the rear wall by appropriate hinge means. Appropriate latch means in Aochi on the container body front wall and cooperating front end of the lid act to selectively retain the lid in the closed position thereof, see Column 1, lines 58-67. Again as in Lin, the cover in Aochi does not primarily teach the retaining of a flexible plastic bin liner on its outer periphery surrounding sidewall termination with the focus again as in Lin upon on the spring pivoted sealing lid portions and the relative movement between the lid and seal annular element.

Further, in the container cover arts in looking at U.S. Pat. No. 4,765,579 to Robbins, III, et al., which is a continuation in part patent of Robbins III et al., '572 hereinafter described, disclosed is a device in Robbins et al., '579 for positionally retaining a flexible trash bag liner relative to a trash receptacle container. The upper portion of the flexible trash bag liner in Robbins III, et al., '579 is draped over the exterior of the upper rim of the container being secured thereto by means of a cooperating lock ring sized and configured to receive the rim's exterior configuration in a nested relationship so as to capture, and thus positionally secure, the flexible liner bag's upper portion thereto. Preferably, in Robbins III, et al., '579 the rim and lock ring are joined to one another by an integral, flexible “live” hinge so that the rim may first be positioned on the receptacle top and the lock ring may thereafter be pivotally moved into cooperating locking relationship thereto and thus provide greater convenience to the user, see Column 3, lines 37-49. The folding cover in Robbins III et al., '579 has an integral “live” hinge section that is very basic in design in so far as the liner retention, however, Robbins III et al., '579 having an air vent channel in fluid communication as between the flexible plastic liner and the container wall to the external environment to help the flexible plastic liner become more adjacent to the container wall by venting trapped air therebetween. There are no specific teachings in Robbins III et al., '579 as the retaining interface between the receptacle top and the lock ring such as snap fits, interference fits, and the like.

Next, in U.S. Design Pat. No. D555,321 to Lin disclosed is an ornamental design for a garbage can lid having an annular element disposed upon the upper garbage can rim, with a hinged door on top of the lid shown in a closed operational state that can allow access to the garbage can interior without having to remove the lid annular element from the garbage can upper rim, note that as this is a design patent there is no teaching as to any particulars on the sectional interface as between the garbage can upper rim and the garbage can lid annular element. Continuing, in U.S. Pat. No. 4,630,752 to DeMars disclosed a trash can wire hoop retainer for retaining trash bags in removable retention utilizing a trash can having two lifting handles and a rim. The retainer in DeMars comprises a wire rod-like body of substantially circular or hoop-like configuration, with means on one side for hingedly engaging the wire in one of the handles of the trash can. Further, in DeMars a means is on the opposite side of the trash can from the hinged engagement handle therefrom to engage the wire rim above the non-hinged handle of the trash can in a clamping relationship to thereby engage a top portion of the flexible plastic trash bag liner in friction-fit relationship as against the upper rim portion of the surrounding sidewall of the garbage can, see Column 1, lines 47-56. DeMars tries to utilize a standard garbage can lid cover with the thin wire rod type band that fits over the outside of the trash can at a point below the cover lid engagement interface, however, requiring that the wire rod band have a custom fit as against the trash can upper rim portion in addition to having to engage into the pivotal connection on one of the trash can handles requiring a unique pivotal interface in the handle.

Further continuing in U.S. Pat. No. 4,715,572 to Robbins III, et al., being the parent application to Robbins III et al., '579 disclosed in Robbins III et al., '572 is a trash bag retainer and air venting device having at least one channel with a generally U-shaped, V-shaped or similarly shaped interior cross-section. Within this cross-section in Robbins III et al., '572 there are a plurality of ribs (or other forms of locking mechanisms) that have a lip (or other forms of latching means) on at least one edge portion of at least some of the ribs so as to more securely engage the device onto the flange or upper rim of the trash container surrounding sidewall. The spaces in Robbins III et al., '572 between the ribs in the interior cross-section of the device serve as a venting means for entrapped air, between the flexible plastic liner the trash can surrounding sidewall and the base portion of the trash can for helping the flexible plastic liner be adjacent to the trash container sidewall, see Column 3, lines 1-12. Basically in Robbins III et al., '572 the removably engagable cover lid is dispensed with as compared to Robbins III et al., '579.

There remains a need for a more practical container cover that can provide the desired function of removably retaining the flexible plastic liner to the upper terminating ridge of the container's surrounding sidewall, while at the same time not requiring any separable loose parts by being integrated to the container cover. This way the removable retaining of the flexible plastic liner is always available in conjunction with the cover. In addition the cover should be removably engagable on its own such that the removable retaining function of the cover to help hold the flexible plastic liner to the upper terminating ridge of the surrounding sidewall of the container remains in place while allowing the cover to be removably engaged on its own.

### SUMMARY OF INVENTION

Broadly, the present invention is of a cover apparatus for a container with an interior and having an open end defined by a sidewall edge portion. The cover apparatus includes an annular element with structure to removably engage the sidewall edge portion. Further included in the cover apparatus is a separable disc that is rotationally removably engaged to the annular element, the disc is sized and configured to allow for one-way axial movement relative to the annular element, such that the disc and the annular element substantially enclose the container interior.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of an annular element and a separable disc in an un-locked assembled operational state forming a cover apparatus, wherein the disc can allow one-way axial movement relative to the annular element;

FIG. 2 shows a perspective view of the annular element and the separable disc in a locked assembled operational state forming a cover apparatus, wherein the disc cannot allow one-way axial movement relative to the annular element;

FIG. 3 shows a perspective view of the annular element and the separable disc in an un-assembled operational state forming the cover apparatus;

FIG. 4 shows a side elevation view of the annular element and the separable disc in a locked and assembled operational state forming the cover apparatus;

FIG. 5 shows a cross sectional view 5-5 from FIG. 2 showing the annular element and the separable disc in a locked and assembled operational state forming a cover apparatus, wherein the disc cannot have one-way axial movement relative to the annular element;

FIG. 6 shows a cross sectional view 6-6 from FIG. 1 showing the annular element and the separable disc in an un-locked and assembled operational state forming a cover apparatus, wherein the disc can have one-way axial movement relative to the annular element allowing movement to the view shown in FIG. 3;

FIG. 7 shows a perspective view of the use of the cover apparatus in the locked and assembled operational state being adapted to removably engage a sidewall edge portion of the container with a flexible container liner adjacent to a container interior that is retained by the interface of the annular element and the sidewall edge portion of the container;

FIG. 8 shows a perspective view of the use of the cover apparatus with the disc removed with the cover apparatus being in the unassembled operational state with the annular element adapted to removably engage the sidewall edge portion of the container with the flexible container liner adjacent to a container interior that is retained by the interface of the annular element and the sidewall edge portion of the container with refuse being deposited therein being within the flexible liner;

FIG. 9 shows an overhead view of the cover apparatus in the un-locked and assembled operational state as between the disc and the annular element being similar to FIG. 1; and

FIG. 10 shows an overhead view of the cover apparatus in the locked and assembled operational state by virtue of a rotational engagement movement as between the disc and the annular element being similar to FIG. 2.

### REFERENCE NUMBERS IN DRAWINGS

30 Cover Apparatus
35 Annular element
40 Structure of annular element 35 to removably engage the sidewall edge portion 220
45 Circumferential channel of annular element 35
50 First channel extension of channel 45
55 Second channel extension of channel 45
60 Web portion of channel 45
65 Relief of first channel extension 50
70 Recess of annular element 35
75 First protrusion of the recess 70
80 Second protrusion of the recess 70
85 Root section of the recess 70
90 Acute angle as between the first protrusion 75 and the second protrusion 80
95 Wider opening from root 85 to termination of the first 75 and second 80 protrusions
100 Partial interference fit of recess 70
105 Non interference fit between the first 75 and second 80 protrusions and the mating sidewall edge portion 220 of the container 205
110 Snap fit of recess and sidewall edge portion 220
115 Lower separating force as between the annular element 35 and the container 205
120 Higher assembling force as between the annular element 35 and the container 205
125 Separable disc
130 Outer periphery of the disc 125
135 Margin extension of the outer periphery 130 of the disc 125
140 Handle of the disc 125
145 Rotational removable engagement of the disc 125 to the annular element 35
150 One-way axial movement of the disc 125 relative to the annular element 35
155 Rotational engagement/disengagement movement of the disc 125 relative to the annular element 35
160 Sizing and configuring of the disc 125 to allow one-way axial movement 150 relative to the annular element 35
165 Alignment of the margin extension 135 and the relief 65
170 Free axial separation of the disc 125 from the annular element 35
175 Receiving outer periphery 130 within the channel 45
180 Relative rotational movement as between the disc outer periphery 130 and the annular element channel 45
185 Substantial enclosing of the container interior 210
190 Un-locked and assembled state of the disc 125 and annular element 35 forming the cover apparatus 30
195 Locked and assembled state of the disc 125 and annular element 35 forming the cover apparatus 30
200 Unassembled state of the disc 125 and annular element 35 forming the cover apparatus 30
205 Container
210 Interior of the container 205
215 Open end of the container 205
220 Sidewall edge portion of the container 205
225 Outer periphery of sidewall edge portion 220
230 Removable engagement of the annular element 35 to the sidewall edge portion 220 of the container 205
235 Flexible container liner
240 Open end portion of the flexible container liner 235
245 Adjacent position of the flexible container liner 235 to the interior 210 of the container 205
250 Retainer interface formed from the removable engagement 230 of the annular element 35 to the sidewall edge portion 220 of the container 205, such that the retainer interface 250 helps retain and secure the flexible liner 235 to the sidewall edge portion 220 of the container 205 and thus also helps keep adjacent 245 the flexible liner 235 to the interior of the container 210
260 To substantially enclose the container interior 210 with the disc 125 and the annular element 35
265 Refuse
270 Depositing or disposing of refuse 265 within the flexible liner 235 that is retained within the interior 210 of the container 205

### DETAILED DESCRIPTION

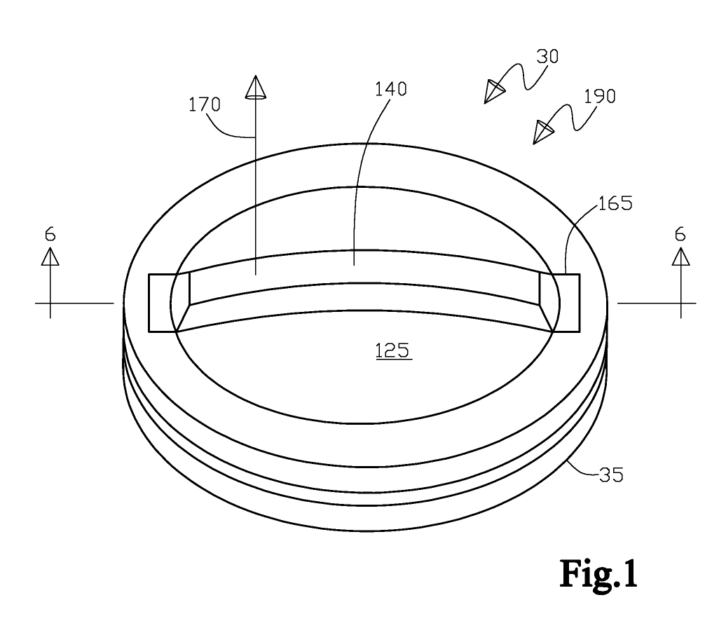

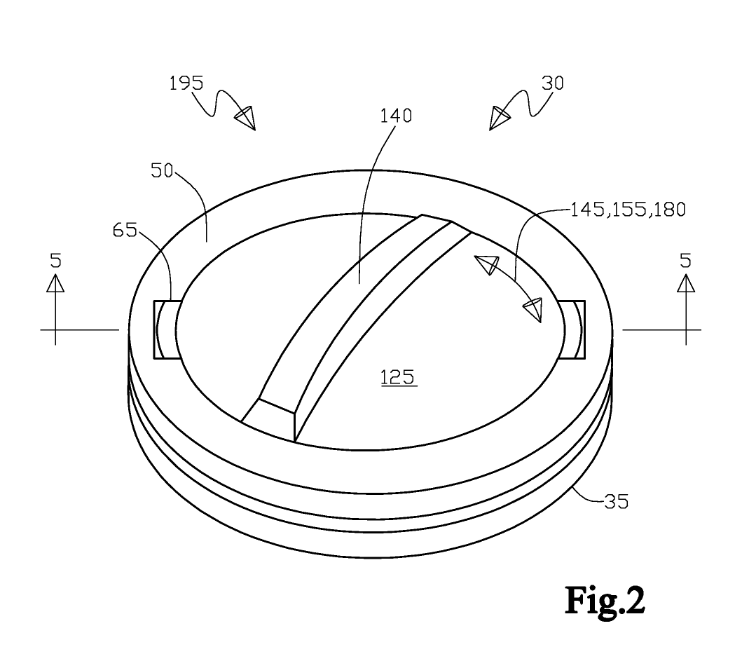

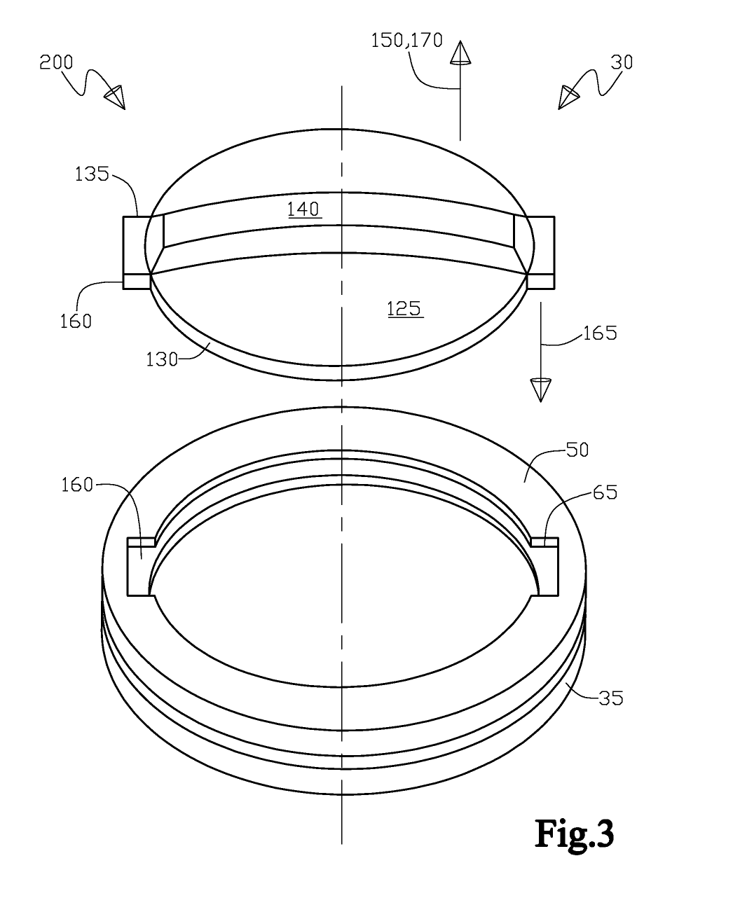

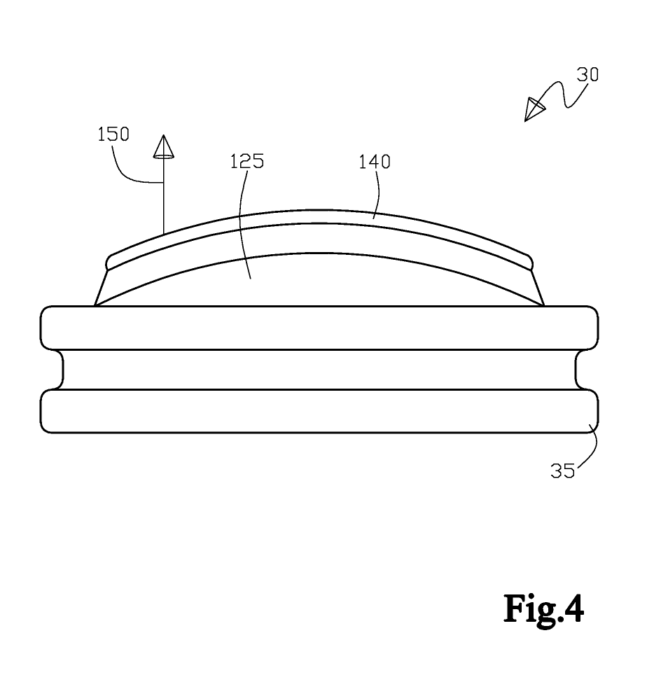

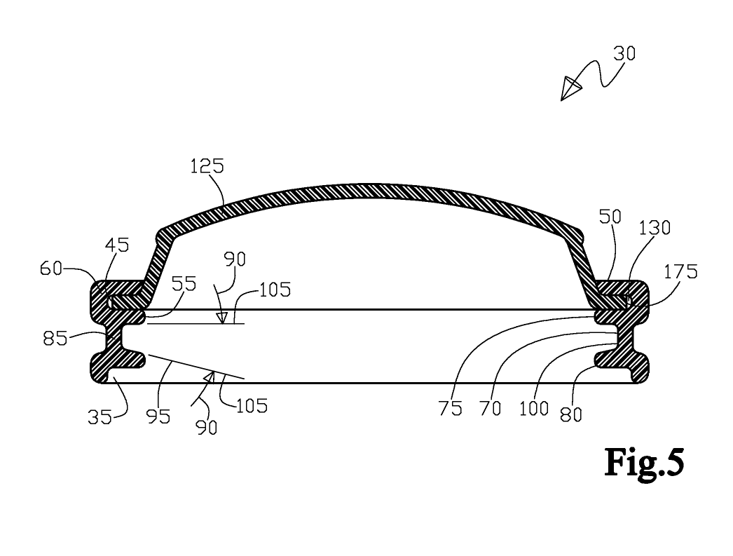

With initial reference to FIG. 1 shown is a perspective view of an annular element 35 and a separable disc 125 in an un-locked assembled operational state 190 forming a cover apparatus 30, wherein the disc 125 can allow one-way axial movement 150 relative to the annular element 35. Further FIG. 2 shows a perspective view of the annular element 35 and the separable disc 125 in a locked assembled operational state 195 forming a cover apparatus 30, wherein the disc 125 cannot allow one-way axial movement 150 relative to the annular element 35. Continuing, FIG. 3 shows a perspective view of the annular element 35 and the separable disc 125 in an un-assembled operational state 200 forming the cover apparatus 30 and FIG. 4 shows a side elevation view of the annular element 35 and the separable disc 125 in a locked and assembled operational state 195 forming the cover apparatus 30. Next, FIG. 5 shows a cross sectional view 5-5 from FIG. 2 showing the annular element 35 and the separable disc 125 in a locked and assembled operational state 195 forming a cover apparatus 30, wherein the disc 125 cannot have one-way axial movement 150 relative to the annular element 35.

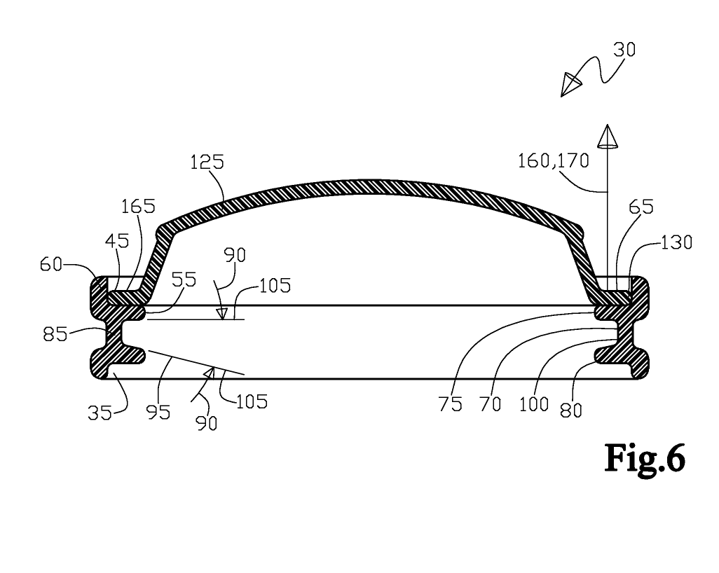

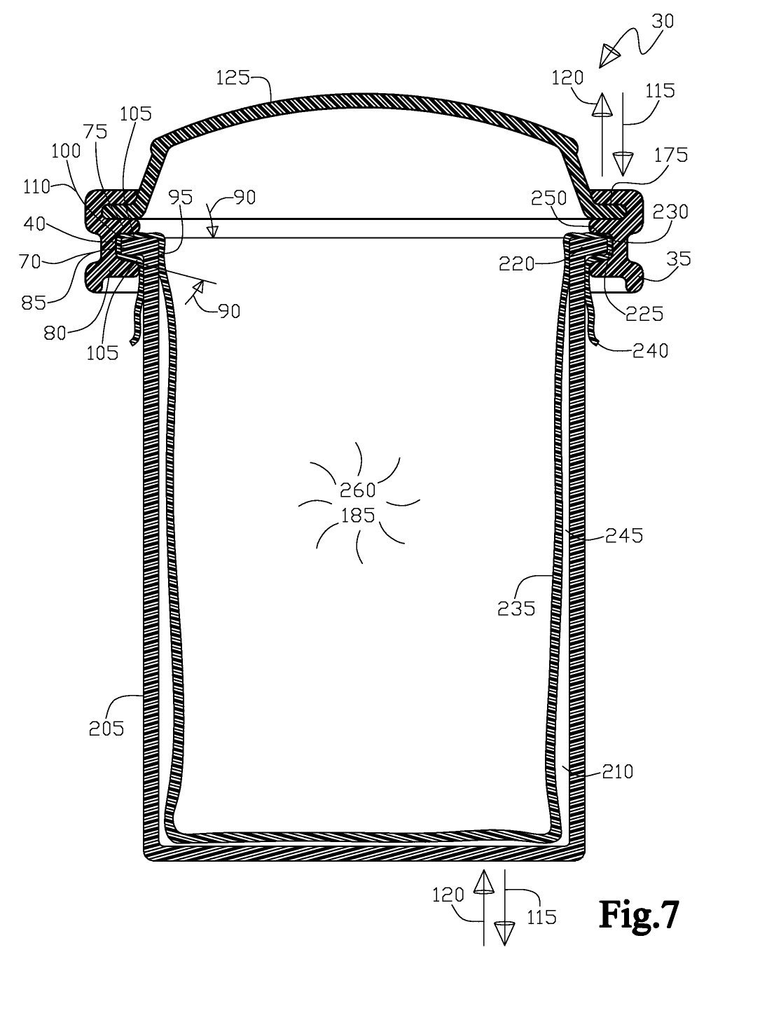

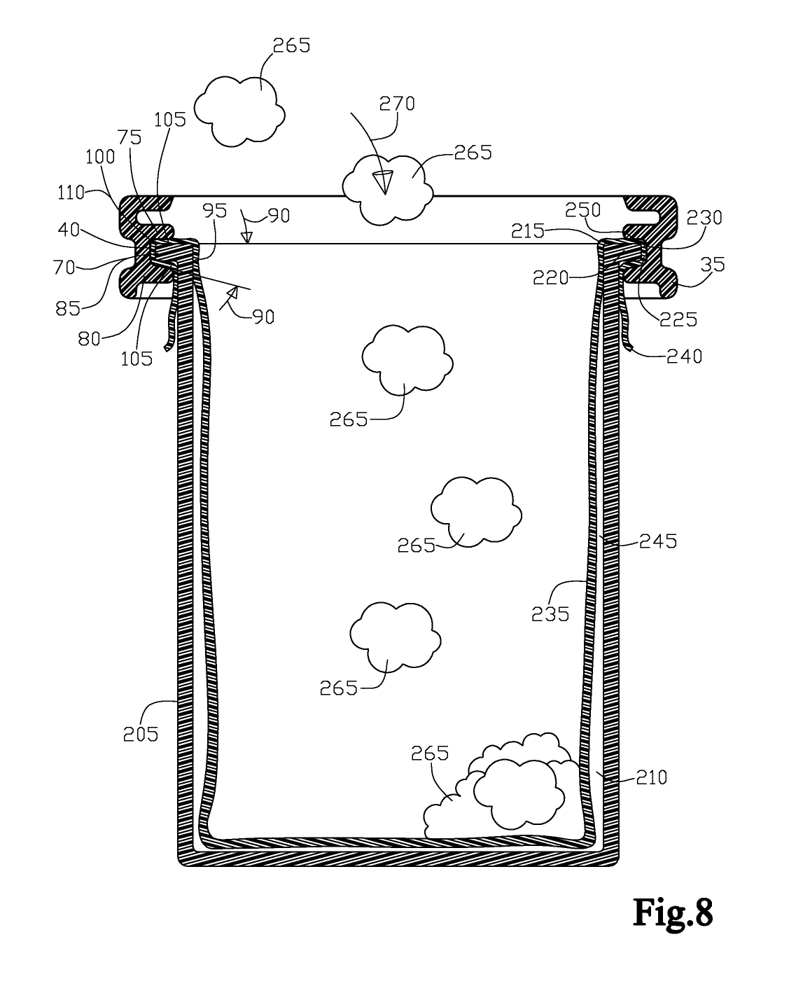

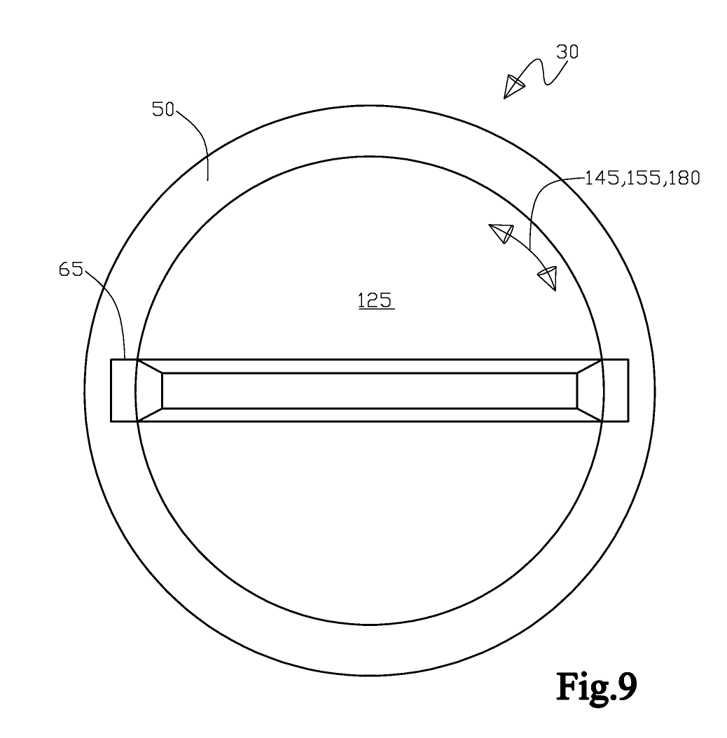

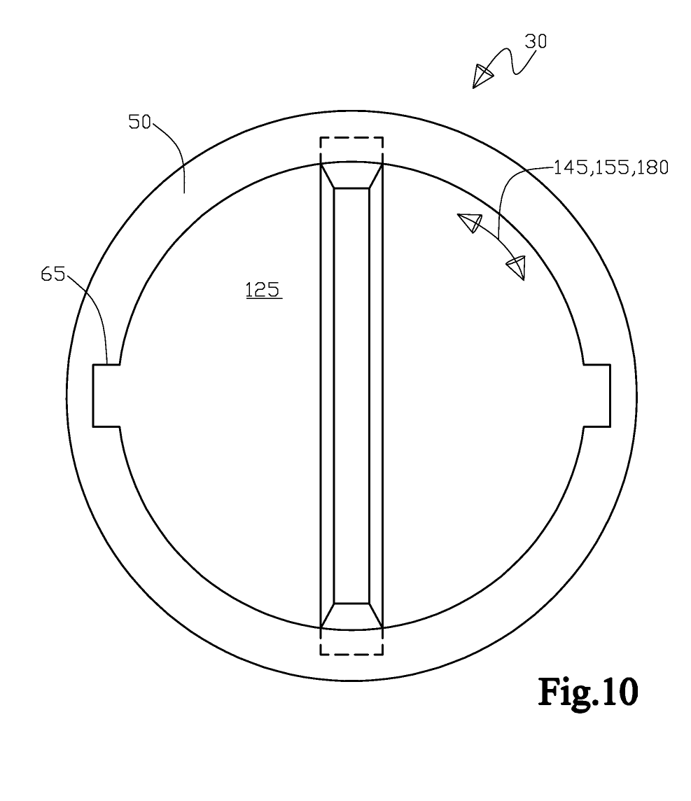

Moving forward, FIG. 6 shows a cross sectional view 6-6 from FIG. 1 showing the annular element 35 and the separable disc 125 in an un-locked and assembled operational state 190 forming a cover apparatus 30, wherein the disc 125 can have one-way axial movement 150 relative to the annular element 35 allowing the one way axial movement 150 to the view shown in FIG. 3. Next, FIG. 7 shows a perspective view of the use of the cover apparatus 30 in the locked and assembled operational state 195 being adapted to removably engage a sidewall edge portion 220 of the container 205 with a flexible container liner 235 adjacent to a container interior 210 that is retained by the interface 250 of the annular element 35 and the sidewall edge portion 220 of the container 205. Yet, further FIG. 8 shows a perspective view of the use of the cover apparatus 30 with the disc 125 removed with the cover apparatus 30 being in the unassembled operational state 200 with the annular element 35 adapted to removably engage 230 the sidewall edge portion 220 of the container 205 with the flexible container liner 235 adjacent to a container interior 210 that is retained 250 by the interface 250 of the annular element 35 and the sidewall edge portion 230 of the container 205 with refuse 265 being deposited 270 therein being within the flexible liner 235. Continuing, FIG. 9 shows an overhead view of the cover apparatus 30 in the un-locked and assembled operational state 190 as between the disc 125 and the annular element 35 being similar to FIG. 1 and FIG. 10 shows an overhead view of the cover apparatus 30 in the locked and assembled operational state 195 by virtue of a rotational engagement movement 155 as between the disc 125 and the annular element 35 being similar to FIG. 2.

Broadly, the present invention is of a cover apparatus 30 for a container 205 with an interior 210 and having an open end 215 defined by a sidewall edge portion 220 as generally depicted in FIGS. 1 to 10. The cover apparatus 30 includes an annular element 35 with structure 40 to removably engage 250 the sidewall edge portion 220, as best shown in FIGS. 7 and 8. Further included in the cover apparatus 30 is a separable disc 125 that is rotationally removably engaged 145 to the annular element 35, the disc 125 is sized and configured 160 to allow for one-way axial movement 150 relative to the annular element 35, such that the disc 125 and the annular element 35 substantially enclose 185 and 260 the container interior 210, also as best shown in FIGS. 7 and 8. Alternatively on the cover apparatus 30, the disc 125 can further comprise an outer periphery 130 that includes a portion of the periphery 130 in the form of a margin extension 135, wherein the outer periphery 130 and the margin extension 135 rotationally 155 removably engage 145 the annular element 35, as best shown in FIGS. 2, 5, and 6.

Further, alternatively the annular element 35 further comprises a circumferential channel 45 defined as having a first channel extension 50, a second channel extension 55, and a web portion 60 positioned therebetween, wherein the first channel extension 50 has a relief 65 that is sized and configured to axially pass therethrough the margin extension 135 and further the circumferential channel 45 rotationally receives the outer periphery 130 of the disc 125 and the margin extension 135, see FIGS. 3, 4, and 5. Wherein, operationally when the margin extension 135 and the relief 65 are in alignment 165 the disc 125 can freely axially separate 170 from the annular element 35 resulting in an unassembled operational state 200 of the disc 125 and the annular element 35, as best shown in FIGS. 1, 3, 5, and 9. Further operationally, when the margin extension 135 and the relief 65 are in alignment 165 with the outer periphery 130 received within 175 the channel 45 the disc 125 and the annular element 35 are in an unlocked and assembled operational state 190. Further, when the margin extension 135 and the relief 65 are not in rotational alignment via relative rotational movement 145, 155, and 180 between the outer periphery 130 and the channel 45 with the outer periphery 130 received 175 within the channel 45, the disc 125 and the annular element 35 are in a locked and assembled operational state 195 best shown in FIGS. 2, 4, 7, and 10.

In addition, optionally, on the cover apparatus 30 the annular element 35 structure 40 to removably engage 230 the sidewall edge portion 220 further comprises a recess 70 that receives in a partial interference fit 100 a mating sidewall edge portion 220 of the container 205, being operational to result in a snap fit 110 between the recess 70 and the sidewall edge portion 220, see FIGS. 5, 6, 7, and 8. Also, on the cover apparatus 30 wherein the recess 70 further includes a first protrusion 75 and a second protrusion 80 with a root section 85 disposed therebetween, see FIGS. 5, 6, 7, and 8. Wherein said first protrusion 75 is adjacent to the second channel extension 55 and the second protrusion 80 forms an acute angle 90 in relation to the first protrusion 75 resulting in the recess 70 angling to a wider opening 95 when going from the root 85 to the terminations of the first 75 and second 80 protrusions. Wherein operationally, the acute angle 90 facilitates a lower separating force 115 required as between the annular element 35 structure 40 and the container 205 as relative to a higher assembling force 120 required as between the annular element 35 and the container 205, as best shown in FIGS. 5, 6, 7, and 8.

Furthermore, on the partial interference fit 100 of the cover apparatus 30, the partial interference fit 100 is defined by an interference fit limited to the root 85 of the recess 70 and an outer periphery 225 of the mating sidewall edge portion 220 of the container 205, as the acute angle 90 results in a non interference fit 105 as between the first 75 and second 80 protrusions and the mating sidewall edge portion 220 of the container 205, see FIGS. 7 and 8. In addition, alternatively on the cover apparatus 30 can further comprise a flexible container liner 235 that is disposed within the container 205 interior 210, wherein the flexible container liner 235 has an open end portion 240 that is disposed within the partial interference fit 100 to help keep the flexible liner 235 adjacent 245 to the interior 210 of the container 205. Wherein the partial interference fit 100 is operational to minimize rupturing of the flexible container liner 235 during assembly 120 and separating 115 of the annular element 35 and the container 205, and further operation to allow for disposing 270 refuse 265 within the flexible container liner 235 that is assisted in retention 250 to the container 205 interior 210 by the partial interference fit 100 with the cover apparatus 30 in the unassembled operational state 200 with the disc 125 separated from the annular element 35, as best shown in FIG. 8.

As another option, on the cover apparatus 30 wherein the disc 125 can further comprise a handle 140 for manual grasping that is operational to further enable the rotational engagement 145, 155, and 180 movement and the free axial separation 170 resulting in the unassembled operational state 200 as between the disc 125 and the annular element 35. For materials of construction, both the annular element 35 and the disc 125 are preferably constructed of a composite that is weatherproof, however, other materials of construction would be acceptable that are also weatherproof and meet the aforementioned function requirements, particularly related to the partial interference fit 100.

### CONCLUSION

Accordingly, the present invention of a cover apparatus 30 has been described with some degree of particularity directed to the embodiments of the present invention. It should be appreciated, though; that the present invention is defined by the following claims construed in light of the prior art so modifications of the changes may be made to the exemplary embodiments of the present invention without departing from the inventive concepts contained therein.

1. A cover apparatus for a container with an interior and having an open end defined by a sidewall edge portion, said cover apparatus comprising:
(a) an annular element including structure to removably engage the sidewall edge portion; and
(b) a separable disc that is rotationally removably engaged to said annular element, said disc is sized and configured to allow for one-way axial movement relative to the said annular element, such that said disc and said annular element substantially enclose the container interior.

2. A cover apparatus according to claim 1, wherein said disc further comprises an outer periphery that includes a portion of said periphery in the form of a margin extension, wherein said outer periphery and said margin extension rotationally removably engage said annular element.

3. A cover apparatus according to claim 2 wherein said annular element further comprises a circumferential channel defined as having a first channel extension, a second channel extension, and a web portion positioned therebetween, wherein said first channel extension has a relief that is sized and configured to axially pass therethrough said margin extension and further said circumferential channel rotationally receives said outer periphery of said disc and said margin extension, wherein operationally when said margin extension and said relief are in alignment said disc can freely axially separate from said annular element resulting in an unassembled operational state of said disc and said annular element, further operationally when said margin extension and said relief are in alignment with said outer periphery received within said channel said disc and said annular element are in an unlocked and assembled operational state, and further when said margin extension and said relief are not in rotational alignment via relative rotational movement between said outer periphery and said channel with said outer periphery received within said channel, said disc and said annular element are in a locked and assembled operational state.

4. A cover apparatus according to claim 3 wherein said annular element structure to removably engage the sidewall edge portion further comprises a recess that receives in a partial interference fit a mating sidewall edge portion of the container, being operational to result in a snap fit between said recess and the sidewall edge portion.

5. A cover apparatus according to claim 4 wherein said recess further includes a first protrusion and a second protrusion with a root section disposed therebetween, wherein said first protrusion is adjacent to said second channel extension and said second protrusion forms an acute angle in relation to said first protrusion resulting in said recess angling to a wider opening when going from said root to terminations of said first and second protrusions, wherein operationally said acute angle facilitates a lower separating force required as between said annular element structure and the container as relative to a higher assembling force required as between said annular element and the container.

6. A cover apparatus according to claim 5 wherein said partial interference fit is defined by an interference fit limited to said root of said recess and an outer periphery of the mating sidewall edge portion of the container, as said acute angle results in a non interference fit as between said first and second protrusions and the mating sidewall edge portion of the container.

7. A cover apparatus according to claim 6 further comprising a flexible container liner that is disposed within the container interior, wherein the flexible container liner has an open end portion that is disposed within said partial interference fit to help keep the flexible liner adjacent to the interior of the container, wherein said partial interference fit is operational to minimize rupturing the flexible container liner during assembly and separating of said annular element and the container due to said non interference fit, and further operation to allow for disposing refuse within the flexible container liner that is assisted in retention to the container interior by said partial interference fit with said cover apparatus in said unassembled operational state with said disc separated from said annular element.

8. A cover apparatus according to claim 7 wherein said disc further comprises a handle for manual grasping that is operational to further enable said rotational engagement movement and said free axial separation resulting in said unassembled operational state as between said disc and said annular element.

9. A cover apparatus for a container with an interior and having an open end defined by a sidewall edge portion, said cover apparatus comprising:
(a) an annular element including structure to removably engage the sidewall edge portion, wherein said annular element further comprises a circumferential channel defined as having a first channel extension, a second channel extension, and a web portion positioned therebetween, wherein said first channel extension has a relief; and
(b) a separable disc that is rotationally removably engaged to said annular element, said disc is sized and configured to allow for one-way axial movement relative to the said annular element, such that said disc and said annular element substantially enclose the container interior, wherein said disc further comprises an outer periphery that includes a portion of said periphery in the form of a margin extension, wherein said outer periphery and said margin extension rotationally removably engage said annular element, said relief is sized and configured to axially pass therethrough said margin extension and further said circumferential channel rotationally receives said outer periphery of said disc and said margin extension, wherein operationally when said margin extension and said relief are in alignment said disc can freely axially separate from said annular element resulting in an unassembled operational state of said disc and said annular element, further operationally when said margin extension and said relief are in alignment with said outer periphery received within said channel said disc and said annular element are in an unlocked and assembled operational state, and further when said margin extension and said relief are not in rotational alignment via relative rotational movement between said outer periphery and said channel with said outer periphery received within said channel, said disc and said annular element are in a locked and assembled operational state.

10. A cover apparatus according to claim 9 wherein said disc further comprises a handle for manual grasping that is operational to further enable said rotational engagement movement and said free axial separation resulting is said unassembled operational state as between said disc and said annular element.

11. A cover apparatus for a container with an interior and having an open end defined by a sidewall edge portion, said cover apparatus comprising:
(a) an annular element including structure to removably engage the sidewall edge portion, wherein said annular element structure to removably engage the sidewall edge portion further comprises a recess that receives in a partial interference fit a mating sidewall edge portion of the container, said recess further includes a first protrusion and a second protrusion with a root section disposed therebetween, wherein said first protrusion is adjacent to said second channel extension and said second protrusion forms an acute angle in relation to said first protrusion resulting in said recess angling to a wider opening when going from said root to terminations of said first and second protrusions, said partial interference fit is defined by an interference fit limited to said root of said recess and an outer periphery of the mating sidewall edge portion of the container, as said acute angle results in a non interference fit as between said first and second protrusions and the mating sidewall edge portion of the container, wherein operationally said acute angle facilitates a lower separating force required as between said annular element structure and the container as relative to a higher assembling force required as between said annular element and the container, and;
(b) a separable disc that is rotationally removably engaged to said annular element, said disc is sized and configured to allow for one-way axial movement relative to the said annular element, such that said disc and said annular element substantially enclose the container interior.

12. A cover apparatus according to claim 11 further comprising a flexible container liner that is disposed within the container interior, wherein the flexible container liner has an open end portion that is disposed within said partial interference fit to help keep the flexible liner adjacent to the interior of the container, wherein said partial interference fit is operational to minimize rupturing the flexible container liner during assembly and separating of said annular element and the container, and further operation to allow for disposing refuse within the flexible container liner that is assisted in retention to the container interior by said partial interference fit with said cover apparatus in said unassembled operational state with said disc separated from said annular element.
